(19) United States
(12) Patent Application Publication
(10) Pub. No.: US 2014/0148095 A1
(43) Pub. Date: May 29, 2014

(54) MULTIPLE ANTENNA ARRANGEMENT FOR NEAR FIELD COMMUNICATIONS

(71) Applicant: BROADCOM CORPORATION, Irvine, CA (US)

(72) Inventors: Aaron Smith, Wokingham (GB); Sekyu Park, Seoul (KR); ByungMan Min, Anyang (KR)

(73) Assignee: BROADCOM CORPORATION, Irvine, CA (US)

(21) Appl. No.: 13/732,192

(22) Filed: Dec. 31, 2012

Related U.S. Application Data
(60) Provisional application No. 61/730,446, filed on Nov. 27, 2012.

(51) Int. Cl. H04B 5/00

(52) U.S. Cl. 455/41.1

(57) ABSTRACT

Various configurations and arrangements of various communication devices and antenna solutions are disclosed. Antenna solutions disclosed herein include a single NFC controller configured to control activation/deactivation of multiple NFC antennas. The single NFC controller can control activation/deactivation of the multiple NFC antennas by providing control signals to a switch which can switch activation/deactivation of each of the multiple antennas based on the received control signals. Various patterns of activation and/or deactivation of the multiple NFC antennas can be implemented by the NFC controller. Upon detection of another NFC capable device by one of the multiple antennas, the NFC controller can freeze the activation state of the multiple antennas until an RF_DEACTIVATE signal is received.

### TECHNICAL FIELD

The present disclosure relates generally to multiple antenna arrangements for implementing near field communications (NFC) within an NFC enabled communication device.

### BACKGROUND

Mobile wireless communication devices such as cellular telephones, two-way radios, personal digital assistants (PDAs), personal computers (PCs), tablet computers, laptop computers, home entertainment equipment, radio frequency (RF) identification (RFID) readers, RFID tags, etc. have evolved from large devices focused on a single application or use, such as analog voice communications, to comparatively smaller devices that are capable of and used for many different things such as digital voice communications and digital data communications, e.g., Short Message Service (SMS) for text messaging, email, packet switching for access to the Internet, gaming, Bluetooth®, Multimedia Messaging Service (MMS) and secure transaction capability to provide some examples. In addition to these capabilities, the mobile wireless communication devices of today have additional non-communication related capabilities, such audio and/or video recording to provide an example, and software applications, such as a calendar and a phone book, to provide some examples.

Near Field Communication (NFC) is one technology being implemented in mobile devices for many present and anticipated applications. NFC can be accomplished by touching or placing two NFC enabled devices in close proximity to each other. NFC can be used for, among other things, contactless transactions, data exchange, and/or setup and mobile provisioning. For example, contactless payment systems can be configured to implement NFC for mobile payment by storing credit card and/or loyalty program information within a virtual wallet in an NFC enabled device which can be touched to or placed in close proximity with an NFC terminal that accepts the credit card and/or loyalty program information to complete the mobile payment transaction. NFC can also be used to bootstrap setup other wireless communication methods such as Bluetooth® and/or WiFi™. An NFC file transfer can be used to automatically complete the steps of enabling, pairing and establishing a Bluetooth® connection, such as for Bluetooth® speakers or headsets, etc. The same principle can be applied to the configuration of Wi-Fi™ networks. NFC data exchange can also be used in social networking situations for exchanging contact information, photos, videos, files, etc.

### BRIEF DESCRIPTION OF THE DRAWINGS

For a more complete understanding of example embodiments of the present disclosure, reference is now made to the following descriptions taken in connection with the accompanying drawings in which:

FIG. 1 illustrates a block diagram of a first exemplary NFC enabled communication device according to an exemplary embodiment of the present disclosure;

FIG. 2 further illustrates the block diagram of the first exemplary NFC enabled communication device according to an exemplary embodiment of the present disclosure;

FIG. 3 illustrates an exemplary front end module that can be implemented within the first exemplary NFC enabled communication device according to an exemplary embodiment of the present disclosure;

FIG. 4 illustrates an exemplary NFC controller and multiple antenna arrangement for implementing NFC in accordance with various embodiments of the present disclosure;

FIG. 5 illustrates an exemplary NFC poll and listen timing duration diagram in accordance with various embodiments of the present disclosure;

FIGS. 6a and 6b illustrate exemplary NFC antenna switch control timing diagrams in accordance with various embodiments of the present disclosure; and

FIG. 7 illustrates another exemplary NFC controller and multiple antenna arrangement for implementing NFC in accordance with various embodiments of the present disclosure.

### DETAILED DESCRIPTION OF THE DISCLOSURE

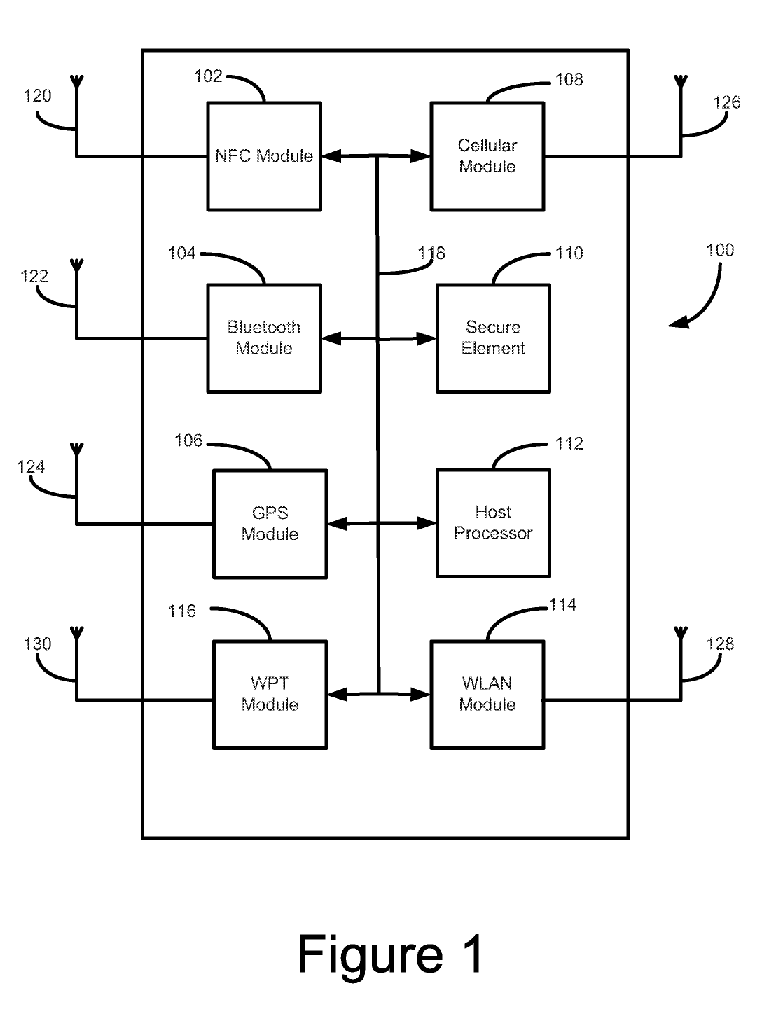

FIG. 1 illustrates a block diagram of one exemplary NFC enabled communication device according to an exemplary embodiment of the present disclosure. An NFC enabled communication device 100 may communicate information over wireless communication networks in accordance with various communication standards. The NFC enabled communication device 100 can represent a mobile communication device, such as a cellular phone or a smartphone, a mobile computing device, such as a tablet computer or a laptop computer, or any other electronic device that is capable of communicating information over communication networks that will be apparent to those skilled in the relevant art(s) without departing from the spirit and scope of the present disclosure.

The NFC enabled communication device 100 can include an NFC module 102, a Bluetooth® module 104, a Global Position System (GPS) module 106, a cellular module 108, a secure element 110, a host processor 112, a wireless local area network (WLAN) module 114, a Wireless Power Transfer (WPT) module 116, or any combination thereof which are communicatively coupled to one another via a communication interface 118. The NFC enabled communication device 100 can also include an NFC antenna 120, a Bluetooth® antenna 122, a GPS antenna 124, a cellular antenna 126, a WLAN antenna 128, and a WPT antenna 130. It should be noted that the NFC enabled communication device 100 need not include all of: the Bluetooth® module 104, the GPS module 106, the cellular module 108, the secure element 110, the host processor 112, the WLAN module 114, the WPT module 116, communication interface 118, the Bluetooth® antenna 122, the GPS antenna 124, the cellular antenna 126, the WLAN antenna 128, and/or the WPT antenna 130. Those skilled in the relevant art(s) will recognize that other configurations and arrangements of the NFC enabled communication device 100 are possible without departing from the spirit and scope of the present disclosure. Additionally, those skilled in the relevant art(s) will also recognize that the NFC module 102, the Bluetooth® module 104, the GPS module 106, the cellular module 108, the secure element 110, the host processor 112, the WLAN module 114, and/or the WPT module 116 need not necessarily be communicatively coupled to one another via the communication interface 118. In some situations, those modules that are communicatively coupled to the communication interface 118 can independently communicate with other communication enabled devices without internal communication.

The NFC module 102 can be configured to provide wireless communications between the NFC enabled communication device 100 and another NFC capable device in accordance with various NFC standards. The NFC module 102 can be configured to operate in an initiator or reader mode of operation to initiate communications with another NFC capable device, or in a target or tag mode of operation to receive communications from another NFC capable device. Additionally, the NFC module 102 may derive or harvest power from the electromagnetic field received from this other NFC capable device when operating in the field power harvesting mode. The power derived or harvested from the received field can sometimes be adequate to power the NFC module 102 and/or the secure element 110.

As explained in more detail below, the NFC module 102 can communicate with other NFC capable devices through the NFC antenna 120. The NFC antenna 120 can comprise multiple inductive coupling elements controlled by a switch and driven by a single NFC controller (NFCC). The multiple inductive coupling elements could be placed in different locations in the NFC enabled communication device 100 to increase the operating volume and provide extended field coverage for the NFC enabled communication device 100.

The Bluetooth® module 104 can be configured to provide wireless communications between the NFC enabled communication device 100 and another Bluetooth® capable device through the Bluetooth® antenna 122 in accordance with various Bluetooth® or Bluetooth® Low Energy (BLE) standards. The Bluetooth® module 104 can be configured to operate in a master mode of operation to initiate communications with another Bluetooth® capable device or in a slave mode of operation to receive communications from another Bluetooth® capable device.

The GPS module 106 can be configured to receive various signals from various satellites through the GPS antenna 124, and to calculate a position of the NFC enabled communication device 100 based on the received signals. The GPS module 106 may be implemented using a Global Navigation Satellite System (GNSS) receiver which can be configured to use the GPS, GLONASS, Galileo and/or Beidou systems for calculating the position of the NFC enabled communication device 100.

The cellular module 108 can be configured to provide wireless communication through the cellular antenna 126 between the NFC enabled communication device 100 and another cellular capable device over a cellular network in accordance with various cellular communication standards such as a Generation Partnership Project (3GPP) Long Term Evolution (LTE) communications standard, a fourth generation (4G) mobile communications standard, or a third generation (3G) mobile communications standard to provide some examples. The cellular module 108 may communicate with one or more transceivers, referred to as base stations or access points, within the cellular network to provide voice and/or data communications between the NFC enabled communication device 100 and another cellular capable device. The transceivers may be connected to a cellular telephone exchange that connects to a public telephone network or to another cellular telephone exchange within the cellular network.

The secure element 110 can be configured to securely store applications and/or information such as payment information, authentication information, ticketing information, and/or marketing information to provide some examples, within the NFC enabled communication device 100, and to provide for an environment for secure execution of these applications. The secure element 110 can be implemented as a separate secure smart card chip, in, among other things, a subscriber identity module (SIM)/Universal Integrated Circuit Card (UICC), or a secure digital (SD) card that can be inserted in the NFC enabled communication device 100.

The host processor 112 can be configured to control overall operation and/or configuration of the NFC enabled communication device 100. The host processor 112 may receive information from, among other things, a user interface such as a touch-screen display, an alphanumeric keypad, a microphone, a mouse, a speaker, and/or from other electrical devices or host devices that are coupled to the NFC enabled communication device 100. The host processor 112 can be configured to provide this information to the NFC module 102, the Bluetooth® module 104, the GPS module 106, the cellular module 108, the secure element 110, the WLAN module 114, and/or the WPT module 116. Additionally, the host processor 112 can be configured to receive information from the NFC module 102, the Bluetooth® module 104, the GPS module 106, the cellular module 108, the secure element 110, the WLAN module 114, and/or the WPT module 116. The host processor 112 may provide this information to the user interface, to other electrical devices or host devices, and/or to the NFC module 102, the Bluetooth® module 104, the GPS module 106, the cellular module 108, the secure element 110, the WLAN module 114, and/or the WPT module 116 via the communication interface 118. Further, the host processor 112 can be configured to execute one or more applications such as SMS for text messaging, electronic mailing, and/or audio and/or video recording to provide some examples, and/or software applications such as a calendar and/or a phone book to provide some examples.

The WLAN module 114 can be configured to provide wireless communications between the NFC enabled communication device 100 and another WLAN capable device over a wired communication network and/or via the WLAN antenna 128 to a wireless communication network in accordance with various networking protocols such a Worldwide Interoperability for Microwave Access (WiMAX) communications standard or a Wi-Fi™ communications standard to provide some examples. The WLAN module 114 can operate as an access point to provide communications between other WLAN capable devices and a communication network, or as a client to communicate with another access point, such as a wireless router to provide an example, to access the communication network.

The WPT module 116 can be configured to provide wireless power transfer between the NFC enabled communication device 100 and another WPT capable device through the WPT antenna 130 in accordance with various WPT standards. The WPT module 102 can be configured to support wireless transmission of power from a wireless power transmitter or another similar electronic device that emits a magnetic field. The WPT module 116 may derive or harvest power from a received WPT signal, such as a magnetic resonance that is provided by the wireless power transmitter. This power that is derived or harvested from the received WPT signal can sometimes be adequate to operate the WPT module 116, the NFC module 102, and/or the secure element 110.

The communication interface 118 can be configured to route various communications between the NFC module 102, the Bluetooth® module 104, the GPS module 106, the cellular module 108, the secure element 110, the host processor 112, the WLAN module 114, and/or the WPT module 116. These communications can include various digital signals, such as one or more commands and/or data to provide some examples, various analog signals, such as direct current (DC) currents and/or voltages to provide some examples, or any combination thereof The communication interface 118, as well as other communication interfaces that are discussed below, can be implemented as a series of wireless interconnections between the NFC module 102, the Bluetooth® module 104, the GPS module 106, the cellular module 108, the secure element 110, the host processor 112, the WLAN module 114, and/or the WPT module 116. The interconnections of the communication interface 118, as well as interconnections of other communication interfaces that are discussed below, can be arranged to form a parallel architecture interface to carry communications between various modules of the NFC enabled communication device 100 in parallel using multiple conductors, a resonant interface to carry communications between various modules of the NFC enabled communication device 100 using a single conductor, or any combination thereof An NFC enabled communication device, such as the NFC enabled communication device 100 to provide an example, may include one or more integrated circuits that can be configured and arranged to form one or more modules, such as the NFC module 102, the Bluetooth® module 104, the GPS module 106, the cellular module 108, the secure element 110, the host processor 112, the WLAN module 114, and/or the WPT module 116 to provide some examples.

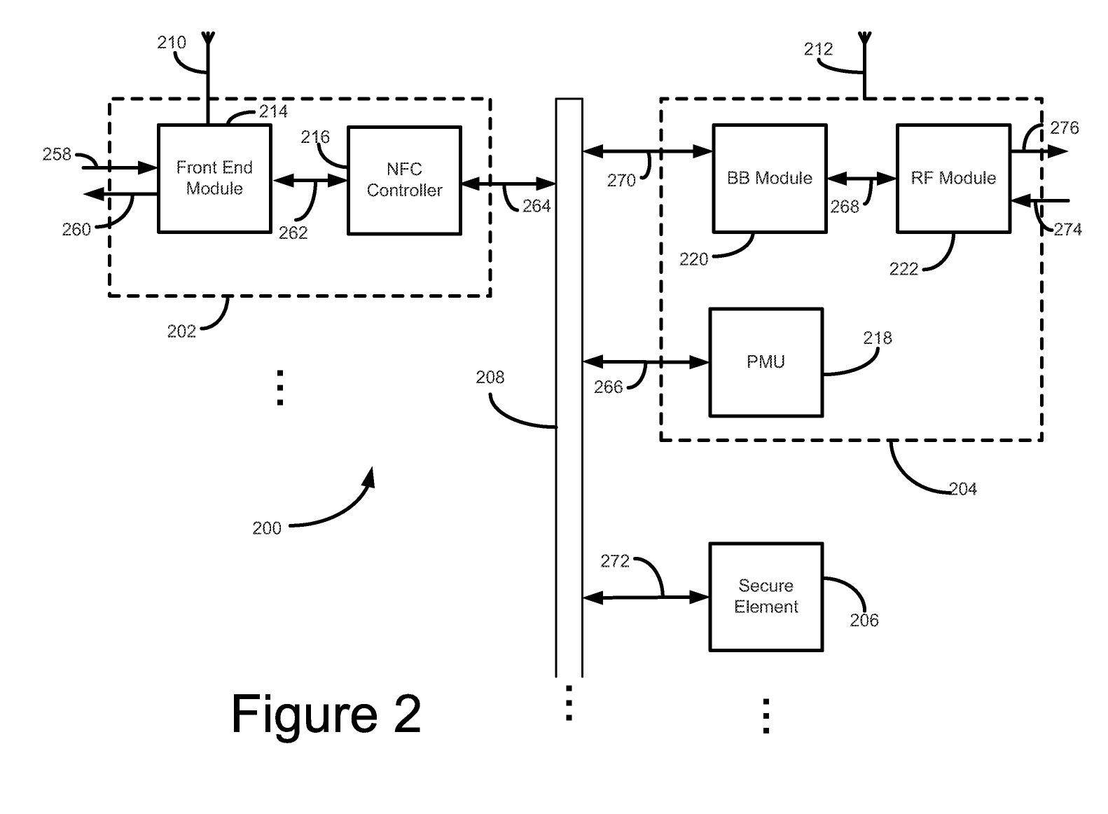

FIG. 2 further illustrates a block diagram of an exemplary NFC enabled communication device according to an exemplary embodiment of the present disclosure. An NFC enabled communication device 200 can include one or more integrated circuits that can be configured and arranged to form one or more modules that are used to communicate information over wireless communication networks in accordance with various communication standards. The NFC enabled communication device 200 may include an NFC module 202, a cellular module 204, and a secure element 206 which can be communicatively coupled to one another via a communication interface 208. An NFC antenna 210 can be connected to the NFC module 202 and a cellular antenna 212 can be connected to the cellular module 204. The NFC enabled communication device 200 can represent another exemplary embodiment of the NFC enabled communication device 100 of FIG. 1. As such, the NFC module 202, the cellular module 204, the secure element 206, and the communication interface 208 can represent an exemplary embodiment of the NFC module 102, the cellular module 108, the secure element 110, and the communication interface 118, respectively. Additionally, the NFC enabled communication device 200 may further include a Bluetooth® module, a GPS module, a host processor, a WLAN module, and/or a WPT module such as the Bluetooth® module 104, the GPS module 106, the host processor 112, the WLAN module 114, and/or the WPT module 116, respectively, of FIG. 1. The Bluetooth® module, the GPS module, the host processor, the WLAN module, and/or WPT module may be communicatively coupled to the NFC module 202, the cellular module 204, and/or the secure element 206 via the communication interface 208.

The NFC module 202 can be configured to provide wireless communications between the NFC enabled communication device 200 and another NFC capable device in accordance with various NFC standards in the reader or in the tag mode of operations in a substantially similar manner as the NFC module 102. In the initiator or reader mode, the NFC module 202 can be configured to actively generate an RF field that provides an NFC communications signal to another NFC capable device and/or power the other NFC capable device if the other NFC capable device is a passive target device. The NFC module 202 can also communicate in a peer-to-peer fashion with another NFC capable device if the other NFC capable device is itself powered. In the tag mode of operation, the NFC enabled communication device 200 can be configured to derive or harvest power from another NFC capable device and to provide the other NFC capable device with tag data. For example, tag data can include personal data, such as debit and/or credit card information, loyalty program data, PINs and/or networking contacts, stored on the secure element 206. Another way to explain the different NFC communications modes are active communication mode and passive communication mode. In active communication mode, both the initiator device and target device communicate alternatively generating their own fields. Generally, one device deactivates its RF field while it is waiting for data, and the other device activates its RF field and couples to the deactivated device through inductive coupling. After receiving the data it needs, the first device may then reactivate its RF field, and the second device may deactivate its RF field and couple itself to the RF field of the first device through inductive coupling. In this mode, both the initiator and target devices typically have their own power supply. In passive communication, the initiator device can provide a carrier field, and the target device can answer by modulating the provided carrier field. In this mode, the target device may draw its operating power from the electromagnetic field generated by the initiator device.

The NFC module 202 can include a front end module (FEM) 214 and/or an NFC controller 216. FEM 214 can be configured to provide an interface between the NFC module 202 and another NFC capable device. In one embodiment, the FEM 214 can be configured as an RF front end, such as, for example, an analog high voltage system possibly based on a generally larger gate process, in conjunction with a digital back-end, such as, for example, a low voltage system possibly based on a generally small gate process. When the NFC module 202 is operating in the reader mode of operation, the FEM 214 can be configured to generate a magnetic field, sometimes referred to as a transmitted NFC communication signal 260, which can be modulated by another NFC capable device with information to form an NFC communication signal 258 that may be received by the FEM 214/NFC module 202. The FEM 214 can also modulate the magnetic field with information, such as data and/or one or more commands, that are received from a front end module controller (FEM-CTRLR) communication interface 262 to form the transmitted NFC communication signal 260 when the NFC module 202 is operating in the reader mode of operation. Alternatively, when the NFC module 202 is operating in the tag mode of operation, the FEM 214 can be configured to inductively receive an NFC communication signal 258 which may represent a magnetic field generated by another NFC capable device that can be modulated with information. The FEM 214 can also modulate the received NFC communication signal 258 with information, such as data and/or one or more commands, that are received from a FEM-CTRLR communication interface 262 to form the transmitted NFC communication signal 260 when the NFC module 202 is operating in the tag mode of operation. The FEM 214 can be configured to derive or harvest power from the received NFC communication signal 258 and provide the harvested NFC power to the NFC controller 216 via the FEM-CTRLR communication interface 262.

The FEM 214 can be configured to recover and then provide information from the received NFC communication signal 258 to the NFC controller 216 via the FEM-CTRLR communication interface 262 when the NFC module 202 is operating in the reader and tag modes of operation. Specifically, the FEM 214 may convert its own magnetic field when the NFC module 202 is operating in the reader mode of operation, or the magnetic field generated by another NFC capable device when the NFC module 202 is operating in the tag mode of operation, into a voltage and/or a current, and recover the information from the voltage and/or the current.

The NFC controller 216 can control overall operation and/or configuration of the NFC module 202. The NFC controller 216 can be configured to receive information and/or the harvested NFC power from the FEM 214 via the FEM-CTRLR communication interface 262. Additionally, the NFC controller 216 can route the information and/or the harvested NFC power from the FEM-CTRLR communication interface 262 to a controller communication interface (CTRLR-CI) 264 for routing to the NFC module 202, the cellular module 204, the secure element 206, and/or other modules within the NFC enabled communication device 200 via the communication interface 208. Further, the NFC controller 216 can receive information from the NFC module 202, the cellular module 204, the secure element 206, and/or other modules within the NFC enabled communication device 200 via the CTRLR-CI 264. The NFC controller 216 can route the information received from the CTRLR-CI 264 to the FEM 214 via the FEM-CTRLR communication interface 262. Further, the NFC controller 216 can execute one or more commands provided by the information from the FEM-CTRLR communication interface 262 and/or the CTRLR-CI 264 to control overall operation and/or configuration of the NFC module 202.

The cellular module 204 can be configured to provide wireless communication between the NFC enabled communication device 200 and another cellular capable device over a cellular network in accordance with various cellular communication standards in a substantially similar manner as the cellular module 108. The cellular module 204 can include a power management unit (PMU) 218, a baseband module 220, a radio frequency module 222 and a cellular antenna 212.

The PMU 218 may be configured to take responsibly for battery and power system management of the cellular module 204 and/or the NFC enabled communication device 200. The PMU 218 can be configured to receive various power signals from the NFC module 202, the cellular module 204, the secure element 206, and/or other modules within the NFC enabled communication device 200 from the communication interface 208 via a PMU communication interface (PMU-CI) 266. In one embodiment, the PMU 218 can be configured to monitor the power signals received from the PMU-CI 266 to monitor current, voltages, and/or temperature readings within the NFC enabled communication device 200. Additionally, the PMU 218 can be configured to use the power signals received from the PMU-CI 266 to monitor power connections and battery charges and/or to charge batteries when necessary. Further, the PMU 218 can be configured to use the power signals received from the PMU-CI 266 to control and/or to provide other power signals to the NFC module 202, the secure element 206, and/or other modules within the NFC enabled communication device 200 via the communication interface 208.

The baseband module 220 can be configured to control operation of the cellular module 204. The baseband module 220 may receive information from the RF module 222 via a broadband-radio frequency module (BB-RFM) communication interface 268. Additionally, the baseband module 220 can be configured to provide the information from the BB-RFM communication interface 268 to a baseband communication interface (BB-CI) 270 for routing to the NFC module 202, the secure element 206, and/or other modules within the NFC enabled communication device 200 via the communication interface 208. Further, the baseband module 220 can be configured to receive information from the NFC module 202, the secure element 206, and/or other modules within the NFC enabled communication device 200 from the communications interface 208 via the BB-CI 270. The baseband module 220 can route the information received from the BB-CI 270 to the RF module 222 via the BB-RFM communication interface 268. Further, the baseband module 220 can be configured to execute one or more commands provided by the information from the BB-RFM communication interface 268 and/or the BB-CI 270 to control overall operation and/or configuration of the cellular module 204.

The RF module 222 can be configured to downconvert, demodulate, and/or decode a received cellular communication signal 274 to provide information to the baseband module 220 via the BB-RFM communication interface 268. The RF module 222 can convert the received cellular communication signal 274 from an analog representation to a digital representation. The RF module 222 can also be configured to upconvert, modulate, and/or encode information received from the baseband module 220 via the BB-RFM communication interface 268 to provide a transmitted cellular communication signal 276. The RF module 222 can also convert the information received from the BB-RFM communication interface 268 from a digital representation to an analog representation.

The secure element 206 can be configured to securely store applications and/or information within the NFC enabled communication device 200 and provide for an environment for secure execution of these applications in a substantially similar manner as the secure element 110. The secure element 206 can also be configured to receive the applications and/or the information from the NFC module 202, the cellular module 204, and/or other modules within the NFC enabled communication device 200 from the communication interface 208 via a Secure Element communications interface (SE-CI) 272. The secure element 206 can provide the information and/or other information generated by the applications to the SE-CI 272 for routing onto the NFC module 202, the cellular module 204, and/or other modules within the NFC enabled communication device 200 via the communication interface 208.

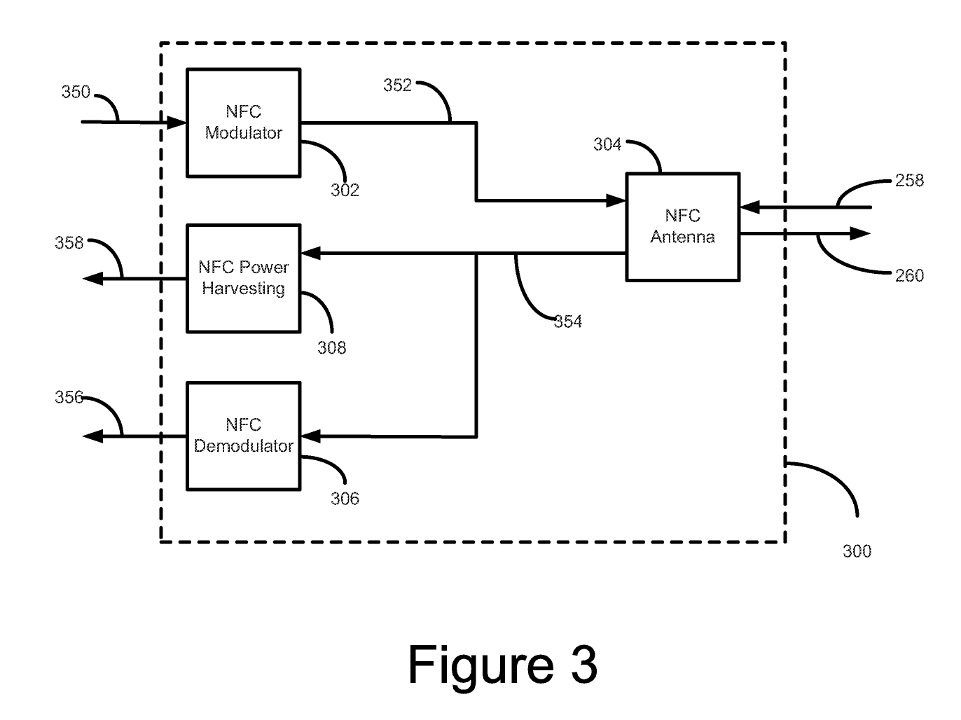

FIG. 3 illustrates one exemplary FEM 300 that can be implemented within an exemplary NFC enabled communication device according to exemplary embodiments of the present disclosure. The FEM 300 can be configured to provide an interface between an NFC enabled communication device, such as the NFC enabled communication device 100 or the NFC enabled communication device 200 to provide some examples, and an NFC capable device. The FEM 300 can be configured to inductively receive various signals from the NFC capable device and recover information and various power signals from these various signals. The FEM 300 can include an NFC modulator module 302, an NFC antenna module 304, an NFC demodulator module 306, and an NFC power harvesting module 308. The FEM 300 can also represent an exemplary embodiment of the FEM 214.

The NFC modulator module 302 can be configured to modulate transmission information 350 onto a carrier wave, such as an RF carrier wave using any suitable analog or digital modulation technique to provide a modulated information signal 352 when the NFC enabled communication device is operating in the reader mode of operation. One commonly used carrier wave frequency for NFC applications is 13.56 MHz, however, other frequencies can be used without departing from the spirit and scope of the present disclosure. Suitable analog or digital modulation techniques may include, among others, amplitude modulation (AM), frequency modulation (FM), phase modulation (PM), phase shift keying (PSK), frequency shift keying (FSK), amplitude shift keying (ASK), quadrature amplitude modulation (QAM) and/or any other suitable modulation technique that will be apparent to those skilled in the relevant art(s). The transmission information 350 can be received from other modules of the NFC enabled communication device over a communication interface, such as the FEM-CTRLR communication interface 262 to provide an example. In some situations, the NFC modulator module 302 can simply provide the carrier wave as the modulated information signal 352. Additionally, the NFC modulator module 302 can be configured to modulate the transmission information 350 using the suitable analog or digital modulation technique to provide the modulated information signal 352 when the NFC enabled communication device is operating in the tag mode of operation.

The antenna module 304 can be configured to inductively receive the NFC communication signal 258 from another NFC capable device to provide a recovered NFC communication signal 354. Additionally, the antenna module 304 can be configured to provide the transmitted NFC communication signal 260 based upon the modulated information signal 352. As mentioned above and described in more detail below, the antenna module 304 can include multiple inductive coupling elements, controlled by a switch and driven by an NFCC. The multiple inductive coupling elements could be placed in different locations within the NFC enabled device to increase the operating volume and provide extended field coverage for the NFC enabled device. When the NFC enabled communication device is operating in the reader mode of operation, the antenna module 304 can apply the modulated information signal 352 to one or more of the multiple inductive coupling elements to generate a magnetic field that represents the transmitted NFC communication signal 260. Alternatively, the antenna module 304 can apply the modulated information signal 352 to one or more of the multiple inductive coupling elements of the antenna module 304 to modulate a magnetic field from another NFC capable device that is inductively coupled to one or more of the multiple inductive coupling elements of the antenna module 304 with the modulated information signal 352 to provide the transmitted NFC communication signal 260.

The NFC demodulator module 306 can be configured to demodulate the recovered NFC communication signal 354 to extract a recovered information signal 356 that was modulated using any suitable analog or digital modulation technique. The suitable analog or digital modulation technique may include, among others, AM, FM, PM, PSK, FSK, ASK, QAM and/or any other suitable modulation technique that will be apparent to those skilled in the relevant art(s). The recovered information signal 356 can be provided to other modules of the NFC enabled communication device over a communication interface, such as the FEM-CTRLR communication interface 262 to provide an example.

The NFC power harvesting module 308 can be configured to derive or harvest power from the recovered NFC communication signal 354 to provide a harvested NFC power 358. In an exemplary embodiment, the NFC power harvesting module 308 can include a rectifier to rectify the recovered NFC communication signal 354 to provide rectified NFC power. In one exemplary embodiment, the NFC power harvesting module 308 can additionally include a regulator to regulate the rectified NFC power to provide the harvested NFC power 358. In some situations, the harvested NFC power 358 can be provided to other modules of the NFC enabled communication device over a communication interface, such as the FEM-CTRLR communication interface 262 to provide an example.

NFC communications work generally on the principle of resonant inductive coupling. Resonant inductive coupling is the near field wireless transmission of electrical energy between two coils that are tuned to resonate at the same or very similar frequency. In practice, an NFC enabled device can act as an NFC transmitter by applying an oscillating current to a coil to create an oscillating magnetic field. Another NFC capable device having a coil resonating at the same or similar frequency as the oscillating magnetic field that is placed in the oscillating magnetic field near the NFC transmitter can couple with the NFC transmitter, thereby picking up energy and/or information from the oscillating magnetic field.

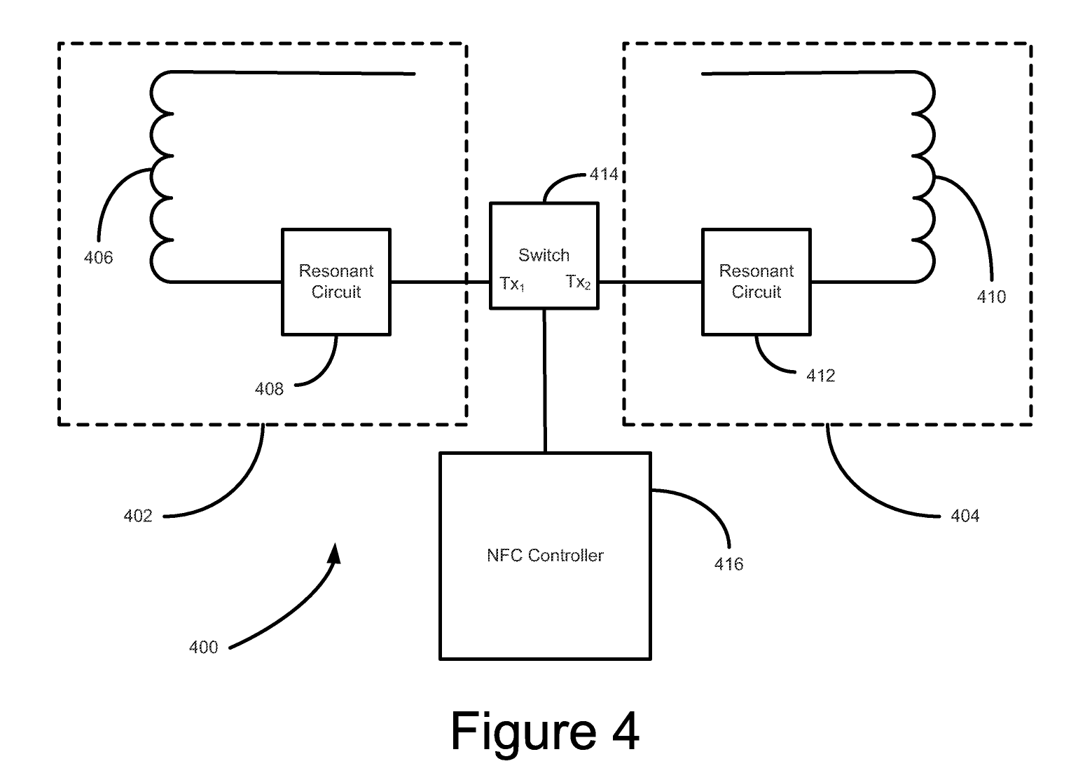

FIG. 4 illustrates an exemplary NFCC and multiple antenna arrangement for implementing NFC in accordance with various embodiments of the present disclosure. The NFCC controller and multiple antenna arrangement can be implemented within an exemplary NFC enabled communication device (such as NFC enabled communication devices 100 and/or 200) according to exemplary embodiments of the present disclosure. One exemplary NFCC and multiple antenna arrangement 400 for implementing NFC in accordance with various embodiment of the present disclosure can be made up of a first antenna 402 including a first inductive coupling element 406 and a first resonant circuit 408, a second antenna 404 including a second inductive coupling element 410 and a second resonant circuit 412, a switch 414, and an NFCC 416. In another exemplary embodiment, the switch 414 can be implemented as part of the NFCC 416.

The first resonant circuit 408 can be configured to tune the first inductive coupling element 406 to resonate at a frequency suitable for implementing NFC communications, while the second resonant circuit 412 can be configured to tune the second inductive coupling element 410 to resonate at a frequency suitable for implementing NFC communications. In one exemplary embodiment, the first inductive coupling element 402 and the second inductive coupling element 406 may comprise coils and the frequency suitable for implementing NFC communication can be 13.56 MHz. In one exemplary embodiment, the first antenna 402 can be positioned in one location within the NFC enabled communication device (e.g. NFC enabled communication devices 100 and/or 200), such as proximate to the front side of the device, and the second antenna 404 can be positioned in another location within the NFC enabled communication device, such as proximate to the back side of the NFC enabled communication device. In another exemplary embodiment, the first antenna 402 and second antenna 404 can be positioned at various locations inside the NFC enabled communication device to compensate for metal or other field interferers present in the NFC enabled communication device which might degrade the operating volume of the NFC enabled communication device. While the exemplary embodiment described herein includes two antennas, it will be apparent to those skilled in the relevant art(s) that more than two antennas may be implemented without departing form the spirit and scope of the present disclosure.

The first inductive coupling element 406 and the second inductive coupling element 410 can be the same size or can be different sizes depending on the situation. For example, the size of each inductive coupling element can be determined based on its location in the NFC enabled communication device and space restrictions provided by this location. In one exemplary implementation, the NFC enabled communication device could be a tablet computer with a touch screen interface. In this situation, the touch screen interface on the front side of the NFC enabled communication device may take up most of the real estate of the NFC enabled communication device restricting the space available to place the first antenna. Typically, the back side of a tablet computer does not have these same space restrictions. As such, an NFCC and multiple antenna arrangement may be designed in accordance with various embodiments, in which the first antenna, placed near the front side of the NFC enabled communication device, is relatively small, while the second antenna, placed near the back side of the NFC enabled communication device, is relatively large to help compensate for the size restrictions placed on the first antenna. Alternatively, more than two antennas may be located at various positions near the front side of the NFC enabled communication device to help compensate for these size restrictions. Additional antennas can be located a various positions within the NFC enabled communication device to enhance the operating volume of the NFC enabled communication device as desired.

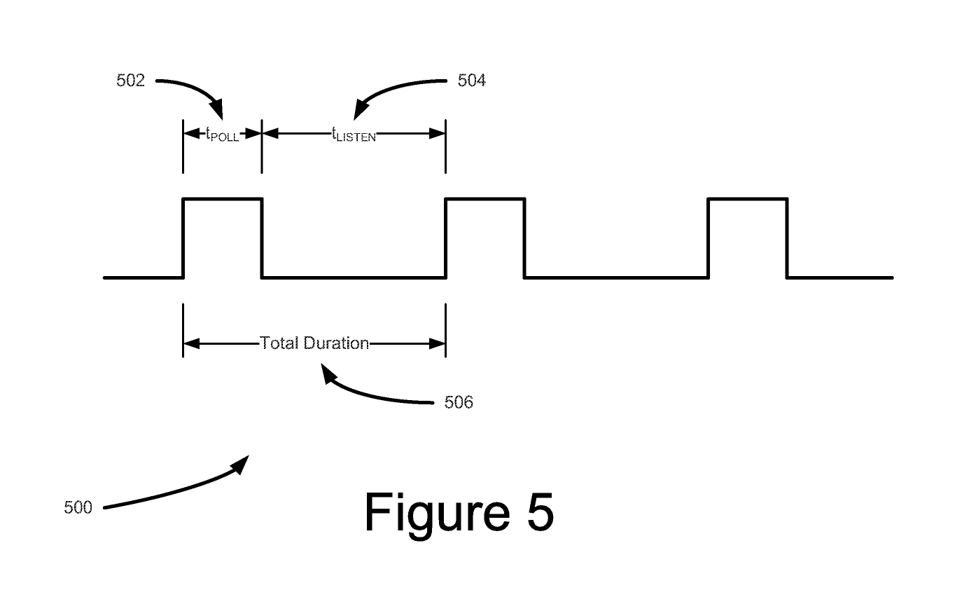

In one exemplary embodiment, time division multiplexing can be implemented to control and drive the multiple antennas (such as antennas 402 and 404). The NFCC 416 can be connected to the switch 414, which, in turn, can be connected to the first antenna 402 and the second antenna 404. The switch 414 can be configured to implement antenna switch selection control over the multiple antennas in cooperation with the NFCC 416. For example, in some embodiments, active NFC can be implemented using various poll and listen algorithms. FIG. 5 illustrates an exemplary NFC poll and listen algorithm 500. In an exemplary poll and listen algorithm implemented in an NFC enabled communication device with one antenna, the NFC enabled communication device typically deactivates its RF field in listening mode during the period t_{LISTEN} 504 when it is waiting for data, and reactivates its RF field in polling mode during the period t_{POLL} 502 when it is searching for another NFC capable device. In one embodiment, the total duration 506 of a sample polling/listening interval cycle can be between 300 ms and 1000 ms.

The NFCC 416 can use a general purpose input/output (GPIO) control signal to drive the switch 414 to select one of the first or second antennas (402 or 404) and cause it to reactivate its RF field on specific turns. In an exemplary embodiment of an NFCC and multiple antenna arrangement according to the present disclosure, the NFCC 416 can use, for example, the total duration 506 of the polling/listening interval cycle as interval for activating one of the multiple antenna. For example, the NFCC 416 can send a GPIO control signal to the switch 414 to select and drive the first antenna 402 while deactivating the second antenna 404 during a first polling/listening interval cycle and then select and drive the second antenna 404 while deactivating the first antenna 402 during the second polling/listening interval cycle. The NFCC 416 can repeat this alternating antenna selection for each poll/listening interval cycle until the NFCC 416 detects a peer device. Detecting a peer device can be identified by an RF_ACTIVATE indication during poll or listening. When the NFCC 416 detects a peer device, the GPIO can maintain the previous antenna selection until an RF_DEACTIVATE occurs.

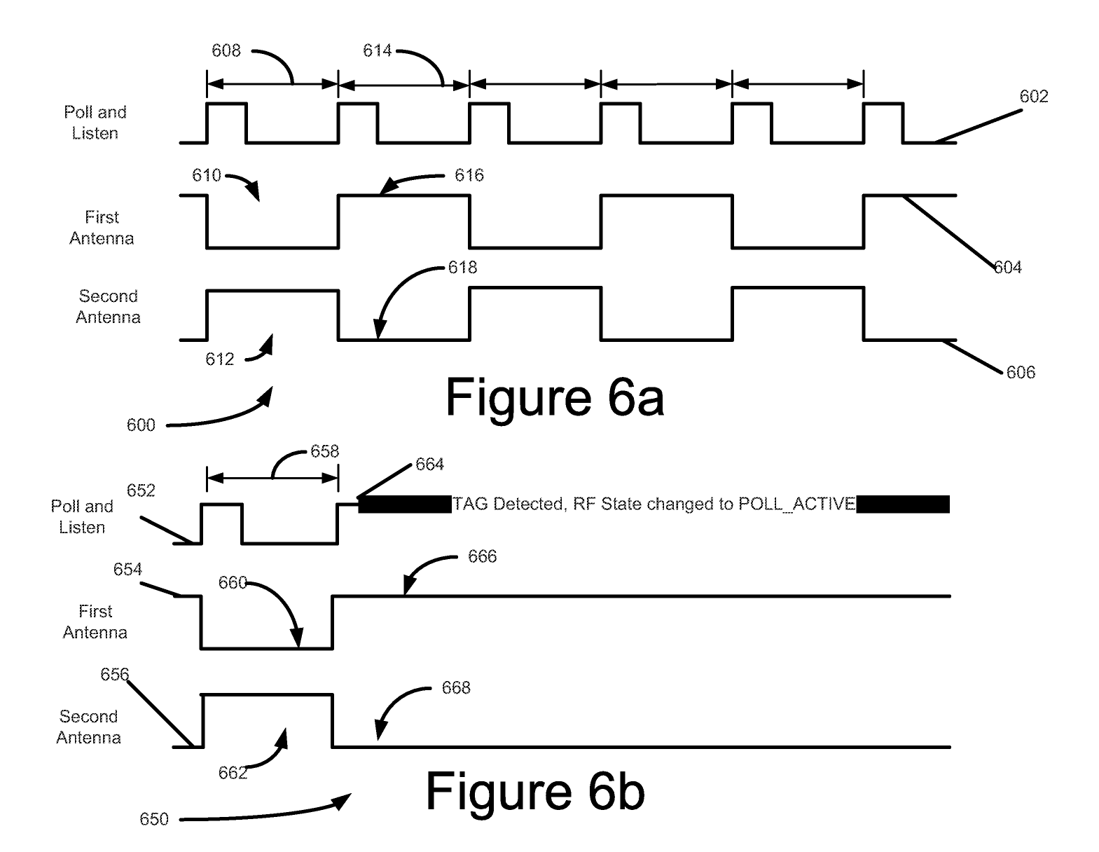

FIG. 6a illustrates one exemplary embodiment of antenna switch selection control 600 of the NFC enabled communication device according to the present disclosure. A poll and listen state diagram 602 shows several cycles of a poll and listen algorithm such as the NFC poll and listen algorithm 500. State diagrams 604 and 606 illustrate exemplary first and second antenna switch selection control activation diagrams, respectively, based on exemplary poll and listen state diagram 602. During the first poll and listen cycle 608, the NFCC (such as NFCC 416) can send a GPIO control signal to the switch (such as switch 414) which, in turn, can deactivate 610 the first antenna (such as antenna 402) placing the first antenna in listening mode. The GPIO control signal sent from the NFCC (such as NFCC 416) also signals the switch (such as switch 414) to activate 612 the second antenna (such as antenna 404) during the same poll and listen cycle 608, placing the second antenna in polling mode. If no peer device is detected during the first poll and listen cycle 608, the poll and listen algorithm can move on to the second poll and listen cycle 614. During the second poll and listen cycle 614, the NFCC (such as NFCC 416) can send a GPIO control signal to the switch (such as switch 414) which, in turn, activates 616 the first antenna (such as antenna 402) placing the first antenna in polling mode, and deactivates 618 the second antenna (such as antenna 404) placing the second antenna in listen mode. If no peer device is detected during the second poll and listen cycle 614, the poll and listen algorithm can repeat itself, alternately deactivating the first antenna (such as antenna 402) while activating the second antenna (such as antenna 404) and then activating the first antenna (such as antenna 402) while deactivating the second antenna (such as antenna 404).

FIG. 6b illustrates an exemplary embodiment of antenna switch selection control 650 during which a peer NFC device is detected. Poll and listen state diagram 652 and corresponding first antenna state diagram 654 and second antenna state diagram 656 illustrate that during a first poll and listen cycle 658 the NFCC (such as NFCC 416) can send a GPIO control signal to the switch (such as switch 414) to deactivate 660 the first antenna (such as antenna 402) and activate 662 the second antenna (such as antenna 404). Since no peer device is detected during the first poll and listen cycle 658, the NFCC (such as NFCC 416) can send a GPIO control signal to the switch (such as switch 414) to activate 666 the first antenna (such as antenna 404) and deactivate 668 the second antenna (such as antenna 404). However, a peer device, such as an NFC tag, may be detected 664 during the second poll and listen cycle which results in an RF_ACTIVATE being produced.

In one exemplary embodiment, the NFCC 416 and switch 414 can be configured to control operation of the first antenna 402 and second antenna 404 only during the RF discovery state. In this embodiment, switch 414 control would remain “frozen” during the other polling/listening interval states. In the example illustrated in FIG. 6b, because an NFC tag is detected by the polling antenna (in this case the first antenna), the RF discover state of the NFC enabled device is changed to poll active and the NFCC (such as NFCC 416) and switch (such as switch 414) “freeze” the activation states of the first and second antennas, the first antenna being activated in polling mode and the second antenna being deactivated in listening mode. This “frozen” state is maintained until an RF_DEACTIVATE occurs. In the case where an NFC peer device is detected by the listening antenna, the RF discover state of the NFC enabled device can be changed to listen active and the NFCC (such as NFCC 416) and switch (such as switch 414) can “freeze” the activation states of the first and second antennas until an RF_DEACTIVATE occurs. If configured, RF_FIELD notifications can be used to inform the NFC enabled communication device about operating fields generated by Remote NFC Endpoints. The NFCC 416 can also be configured to use the RF_FIELD notifications as another source to “freeze” the activation states of the first and second antennas when the NFC enabled communication device is operating in Tag mode.

In one embodiment, the first and second antennas 402 and 404 can have an equal scheduling rate (such as illustrated in FIG. 6a). In other words, the interval in which the first antenna 402 is activated can be equal to the interval in which second antenna 404 is activated, etc. In the embodiment illustrated in FIG. 6a, the interval is equal to the total duration of one polling/listening interval cycle. In another exemplary embodiment, the first antenna 402 can be activated for set number of polling/listening interval cycles (such as more than one polling/listening interval cycle) and then the second antenna can be activated for the same number of polling/listening interval cycles as the first antenna 402. In another embodiment, the first and second antennas 402 and 404 can have weighted scheduling intervals. In other words, the first antenna 402 may be activated for a set number of polling/listening interval cycles and then the second antenna 404 can be activated for a larger or smaller number of polling/listening interval cycles than the first antenna 402. In another embodiment, fractional portions of the polling/listening interval cycles can be used as the measure. For example, the first antenna 402 may be activated for the polling portion (such as interval 502 in FIG. 5) and the second antenna 404 may be activated for the listening portion (such as interval 504 in FIG. 5) of the polling/listening interval.

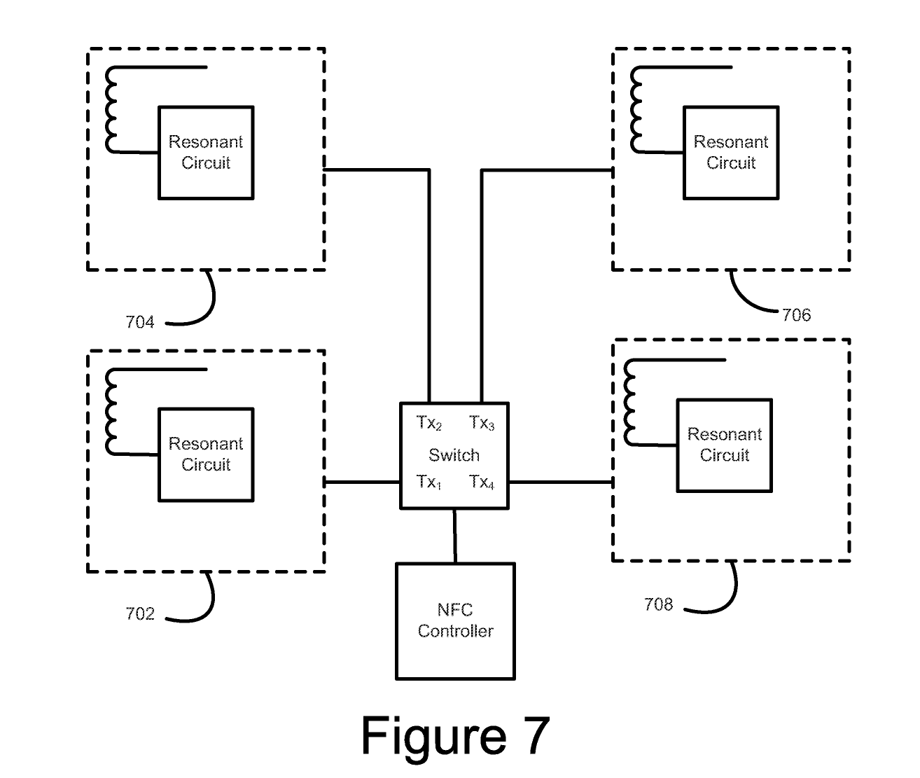

In another exemplary embodiment of the present disclosure, multiple antennas may be activated at the same time. For example, in a situation in which the NFCC antenna arrangement comprises four antenna (as illustrated in FIG. 7), the first and second antennas 702 and 704, respectively, may be activated during the first polling/listening interval cycle, the third antenna 706 may be activated during the second polling/listening interval cycle and the fourth antenna 708 may be activated during the third polling/listening interval cycle. This pattern can be repeated until another NFC capable device is detected. Weighted activation intervals can also be used in this type of arrangement. In another exemplary embodiment of the present disclsoure, the first and second antennas 702 and 704, respectively, may be activated during a first activation period, the first and third antennas 702 and 706, respectively, may be activated during a second activation period, and the first and fourth antennas 702 and 708, respectively, may be activated during the third activation. In fact, any combination of one or multiple antennas, can be activated at a time, in various patterns, with equal or unequal weighted activation intervals without departing from the spirit and/or scope of the present disclosure. In situations where more than one antenna is deactivated at the same time, the receive path may be degraded due to multiple antennas coupling to and sharing the transmitter's magnetic field. Adjusting the sizes of the inductive coupling elements of the antenna to make them varying sizes may be used to compensate for and “gain back” some of the possible degradation.

It should be noted that the present disclosure include various diagrams that may depict an example architectural or other configuration for the various embodiments, which is done to aid in understanding the features and functionality that can be included in embodiments. The present disclosure is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement various embodiments. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

It should be understood that the various features, aspects and/or functionality described in one or more of the individual embodiments are not limited in their applicability to the particular embodiment with which they are described, but instead can be applied, alone or in various combinations, to one or more of the other embodiments, whether or not such embodiments are described and whether or not such features, aspects and/or functionality are presented as being a part of a described embodiment. Thus, the breadth and scope of the present disclosure should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the terms “example” or “exemplary” are used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

Moreover, various embodiments described herein are described in the general context of method steps or processes, which may be implemented in one embodiment by a computer program product, embodied in, e.g., a non-transitory computer-readable memory, including computer-executable instructions, such as program code, executed by computers in networked environments. A computer-readable memory may include removable and non-removable storage devices including, but not limited to, Read Only Memory (ROM), Random Access Memory (RAM), compact discs (CDs), digital versatile discs (DVD), etc. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

As used herein, the term module can describe a given unit of functionality that can be performed in accordance with one or more embodiments. As used herein, a module might be implemented utilizing any form of hardware, software, or a combination thereof. For example, one or more processors, controllers, ASICs, PLAs, PALs, CPLDs, FPGAs, logical components, software routines or other mechanisms might be implemented to make up a module. In implementation, the various modules described herein might be implemented as discrete modules or the functions and features described can be shared in part or in total among one or more modules. In other words, as would be apparent to one of ordinary skill in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software components are used to implement such features or functionality. Where components or modules of the invention are implemented in whole or in part using software, in one embodiment, these software elements can be implemented to operate with a computing or processing module capable of carrying out the functionality described with respect thereto. The presence of broadening words and phrases such as “one or more,” “at least,” “but not limited to” or other like phrases in some instances shall not be read to mean that the narrower case is intended or required in instances where such broadening phrases may be absent.

What is claimed is:

1. An antenna arrangement for facilitating near field communication (NFC) in an NFC enabled communication device, comprising:
at least two antennas;
a switch operably connected to the at least two antennas; and
a single NFC controller operably connected to the switch and configured to control activation/deactivation of the at least two antennas, wherein:
the single NFC controller and the switch are configured to implement antenna switch selection control such that during a radio frequency (RF) discovery state of the NFC enabled communication device, at least one of the at least two antennas is activated while at least one of the at least two antennas is deactivated during a first activation/deactivation interval and if no peer device is detected during the first activation/deactivation interval then another of the at least two antennas is activated while at least one of the at least two antennas is deactivated during a second activation/deactivation cycle, this cycle of activation/deactivation continuing until another NFC capable device is detected.

2. The antenna arrangement of claim 1, wherein when another NFC capable device is detected, the current activation/deactivation status of each of the at least two antennas is frozen.

3. The antenna arrangement of claim 1, wherein one of the at least two antennas is a first size and another of the at least two antennas is a second size that is different than the first size.

4. The antenna arrangement of claim 1, wherein the first activation/deactivation interval is equal in length of time to the second activation/deactivation interval.

5. The antenna arrangement of claim 1, wherein the first activation/deactivation interval is not equal in length of time to the second activation/deactivation interval.

6. The antenna arrangement of claim 1, wherein the location of each of the at least two antennas within the NFC enabled communication device is assigned to increase the operating volume of the antenna arrangement.

7. The antenna arrangement of claim 1, wherein the activation/deactivation intervals are based on a poll and listen algorithm.

8. The antenna arrangement of claim 1, wherein the switch is implemented as part of the NFC controller.

10. A near field communications (NFC) antenna and controller arrangement for facilitating NFC, the arrangement comprising:
a first antenna configured to resonate at a frequency suitable for NFC;
a second antenna configured to resonate at a frequency suitable for NFC;
a switch operably connected to the first antenna and the second antenna;
a NFC controller operably connected to the switch and configured to implement an activation/deactivation sequence for the first and antennas by providing the switch with control signals for controlling activation and deactivation of the first antenna and second antenna based on a poll and listen algorithm, wherein:
the NFC controller sends a control signal to the switch to activate the first antenna placing it in an active state in polling mode and to deactivate the second antenna placing it in a de-active state in listening mode during a first polling/listening interval cycle of the poll and listen algorithm;
if another NFC capable device is not detected by either the first or second antennas during the first polling/listening interval cycle of the poll and listen algorithm, the NFC controller sends a control signal to the switch to deactivate the first antenna placing it in a de-active state in listening mode and to activate the second antenna placing it in active state in polling mode during the next polling/listening interval cycle;
if another NFC capable device is not detected by either the first or second antennas during the second polling/listening interval cycle of the poll and listen algorithm, the NFC controller sends a control signal to the switch to repeat the activation/deactivation sequence of the first and second polling/listening interval cycles;
if another NFC capable device is detected by either the first or second antenna, the NFC controller sends a control signal to the switch to freeze the activate/de-active state of the first and second antennas.

11. The arrangement of claim 10, wherein detection of another NFC capable device is identified by an RF_ACTIVATION indication being received by either the first antenna or the second antenna.

12. The arrangement of claim 10, wherein after detecting another NFC capable device, the switch maintains an activate/de-active state freeze of the first and second antennas until an RF_DEACTIVATE indication is received by either the first antenna or second antenna.

13. The arrangement of claim 10, wherein the NFC controller is configured to only implement the activation/deactivation sequence for the first and second antennas when the NFC device is in an RF discovery state.

14. The arrangement of claim 13, wherein if another NFC capable device is detected by one of the first or second antennas when the detecting antenna is in the active state polling mode, then the NFC device is placed in a poll active mode until an RF_DEACTIVATE indication is received.

15. The arrangement of claim 13, wherein if another NFC capable device is detected by one of the first or second antennas when the detecting antenna is in the de-active state listening mode, then the NFC device is placed in a listen active mode until an RF-DEACTIVATE indication is received.

16. The arrangement of claim 12, wherein upon receipt of the RF_DEACTIVATE indication, the NFC controller is configured to restart the activation/deactivation sequence for the first and second antennas.

17. The arrangement of claim 10, wherein when the NFC enabled communication device is in Tag Mode, RF_FIELD notifications are used to inform the NFC enabled communication device about operating fields generated by Remote NFC Endpoints and wherein the NFC controller uses the RF_FIELD notifications as a source to determine when to send a control signal to the switch to freeze the activate/de-active state of the first and second antennas.

18. The arrangement of claim 10, wherein placement of the first and second antennas within the NFC enabled communication device is configured to compensate for field interferers in the NFC enabled communication device.

19. A method for controlling operation of multiple antennas in an NFC communication device having one NFC controller and a switch, the method comprising:
providing a control signal from the NFC controller to the switch signaling the switch to place a first of the multiple antennas in an activated state by activating the first antenna and to place a second of the multiple antennas in a deactivated state by deactivating the second antenna during a first activation/deactivation interval;
determining whether another NFC capable device is detected by one of the multiple antennas during the first activation/deactivation interval;
if another NFC capable device is detected during the first activation/deactivation interval then freezing the state of the first and second antennas by providing a control signal from the NFC controller to the switch signaling the switch to maintain activation of the first antenna and maintain deactivation of the second antenna;
if another NFC capable device is not detected during the first activation/deactivation interval then providing a control signal from the NFC controller to the switch signaling the switch to place the first antenna in a deactivated state by deactivating the first antenna and to place the second antenna in an activated state by activating the second antenna during a second activation/deactivation interval;
determining whether another NFC capable device is detected by one of the multiple antennas during the second activation/deactivation interval;
if another NFC capable device is detected during the second activation/deactivation interval then freezing the state of the first and second antennas by providing a control signal from the NFC controller to the switch signaling the switch to maintain deactivation of the first antenna and maintain activation of the second antenna; and
if another NFC capable device is not detected during the second activation/deactivation interval then repeating the first activation/deactivation interval and second activation/deactivation interval until another NFC capable device is detected.

20. The method of claim 19, further comprising upon receiving an RF_DEACTIVATION signal from either the first or second antenna while the state of the first and second antennas are frozen, unfreezing the state of the first and second antennas and repeating the first activation/deactivation interval and second activation/deactivation interval until another NFC capable device is detected.
